(19) United States
(12) Patent Application Publication
(10) Pub. No.: US 2024/0403047 A1
(43) Pub. Date: Dec. 5, 2024

(54) VECTOR COMPUTATION APPARATUS, PROCESSOR, SYSTEM ON CHIP AND ELECTRONIC DEVICE

(71) Applicant: Alibaba Innovation Private Limited, Singapore (SG)

(72) Inventor: Zhaohui CHEN, Beijing (CN)

(21) Appl. No.: 18/671,202

(22) Filed: May 22, 2024

(30) Foreign Application Priority Data
May 30, 2023 (CN) 202310627043.1

(51) Int. Cl. G06F 9/30; G06F 15/78

(52) U.S. Cl. CPC G06F 9/30036; G06F 15/7807

(57) ABSTRACT

A vector computation apparatus includes: a register unit including circuitry configured to store a first vector and a second vector respectively and divided into computation channels, each computation channel including a first array including first registers and a second array including second registers; a thread management unit including circuitry configured to determine at least one thread according to the corresponding relationship between at least one first element and at least one second element; and a computation unit including circuitry including a plurality of execution units, each execution unit includes circuitry configured to read a first element and a second element corresponding to each thread in the corresponding computation channel according to at least one thread, execute a modular operation between the first element and second element corresponding to the thread, and write a modular operation result in the first array or second array in the computation channel.

### CROSS-REFERENCE TO RELATED APPLICATIONS

The present application claims priority to and the benefits of Chinese Patent Application No. 202310627043.1, filed on May 30, 2023, which is incorporated herein by reference in its entirety.

### TECHNICAL FIELD

Embodiments of the present disclosure relate to the field of the computer technology, and in particular to a vector computation apparatus, a processor, a system on chip and an electronic device.

### BACKGROUND

In the outsourcing privacy computation based on homomorphic encryption, a client encrypts data and then outsources a computation task to a server, and the server performs a secure computation on the ciphertext. The computational complexity of the ciphertext is much greater than the computational complexity of a plaintext, and thus needs to be supported by a hardware parallel processing technology.

A ciphertext computation task requires a large number of vector modular operations such as vector modular multiplication and vector modular addition. However, the computational efficiency of a vector computation scheme in the existing technology is relatively low.

### SUMMARY

Embodiments of the present disclosure provide a vector computation apparatus. The vector computation apparatus includes: a register unit including circuitry configured to store a first vector and a second vector respectively, the register unit being divided into a plurality of computation channels, each computation channel including a first array including a first register configured to store at least one first element of the first vector and a second array including a second register configured to store at least one second element of the second vector; a thread management unit including circuitry configured to determine at least one thread according to a corresponding relationship between the at least one first element and the at least one second element; and a computation unit including circuitry including a plurality of execution units corresponding to the plurality of computation channels respectively, each execution unit of the plurality of execution units including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

Embodiments of the present disclosure provide a processor. The processor includes: a plurality of processor cores, each processor core being configured as a vector computation apparatus including: a register unit including circuitry configured to store a first vector and a second vector respectively, the register unit being divided into a plurality of computation channels, each computation channel including a first array including a first register configured to store at least one first element of the first vector and a second array including a second register configured to store at least one second element of the second vector; a thread management unit including circuitry configured to determine at least one thread according to a corresponding relationship between the at least one first element and the at least one second element; and a computation unit including circuitry including a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

Embodiments of the present disclosure provide a system on chip. The system on chip includes: a processor including a plurality of processor cores, each processor core being configured as a vector computation apparatus including: a register unit including circuitry configured to store a first vector and a second vector respectively, the register unit being divided into a plurality of computation channels, each computation channel including a first array including a first register configured to store at least one first element of the first vector and a second array including a second register configured to store at least one second element of the second vector; a thread management unit including circuitry configured to determine at least one thread according to a corresponding relationship between the at least one first element and the at least one second element; and a computation unit including circuitry including a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

Embodiments of the present disclosure provide an electronic device. The electronic device includes: a system on chip including a processor, wherein the processor includes a plurality of processor cores and each processor core is configured as a vector computation apparatus including: a register unit including circuitry configured to store a first vector and a second vector respectively, the register unit being divided into a plurality of computation channels, each computation channel including a first array including a first register configured to store at least one first element of the first vector and a second array including a second register configured to store at least one second element of the second vector; a thread management unit including circuitry configured to determine at least one thread according to a corresponding relationship between the at least one first element and the at least one second element; and a computation unit including circuitry including a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

### BRIEF DESCRIPTION OF THE DRAWINGS

In order to more clearly illustrate the technical solutions in the embodiments of the present disclosure or in the conventional art, the accompanying drawings required for descriptions in the embodiments or the conventional art will be briefly introduced below. Apparently, the accompanying drawings in the following description show merely some embodiments of the present disclosure, and a person of ordinary skill in the art may still derive other drawings from these accompanying drawings.

FIG. 1A to FIG. 1C are schematic diagrams of an example vector computation apparatus according to some embodiments of the present disclosure.

FIG. 2 is a schematic block diagram of an example vector computation apparatus according to some embodiments of the present disclosure.

FIG. 3A to FIG. 3B are schematic block diagrams of an example vector computation apparatus according to some embodiments of the present disclosure.

FIG. 4A to FIG. 4C are schematic diagrams of an example vector computation apparatus according to some embodiments of the present disclosure.

FIG. 5 is a schematic block diagram of an example processor according to some embodiments of the present disclosure.

FIG. 6 is a schematic block diagram of an example system on chip according to some embodiments of the present disclosure.

FIG. 7 is a schematic structural diagram of an example electronic device according to some embodiments of the present disclosure.

### DETAILED DESCRIPTION

In order to enable those skilled in the art to better understand the technical solutions in the embodiments of the present disclosure, the technical solutions in the embodiments of the present disclosure will be clearly and completely described below with reference to the accompanying drawings in the embodiments of the present disclosure. It is apparent that the described embodiments are only a part of the embodiments of the present disclosure, but are not all of the embodiments. Based on the embodiments of the present disclosure, all other embodiments obtained by those of ordinary skill in the art should fall within the scope of protection of the embodiments of the present disclosure.

The specific implementation of the embodiments of the present disclosure will be further described below with reference to the accompanying drawings of the embodiments of the present disclosure.

In the embodiments according to the present disclosure, each computation channel includes a first array composed of first registers and a second array composed of second registers, at least one thread is determined according to the corresponding relationship between at least one first element and at least one second element, a first element and a second element can be efficiently read in one thread, and then, a modular operation between the first element and the second element is executed through each execution unit, thus improving the vector computation efficiency between a first vector and a second vector.

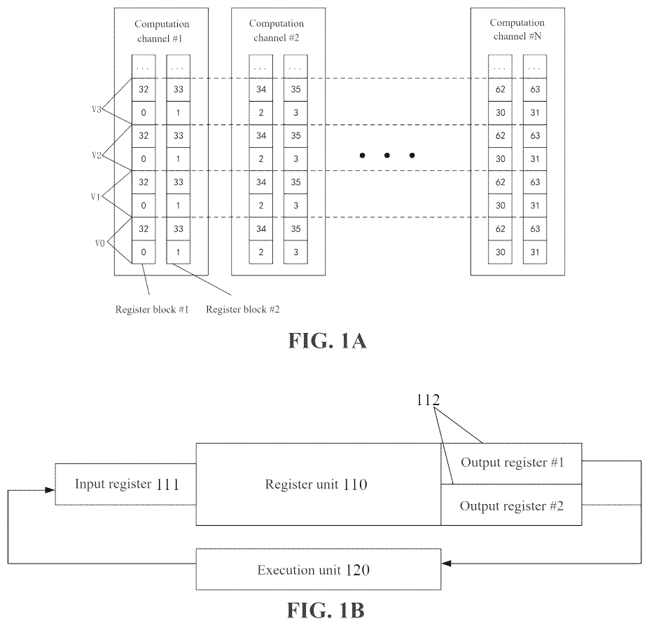

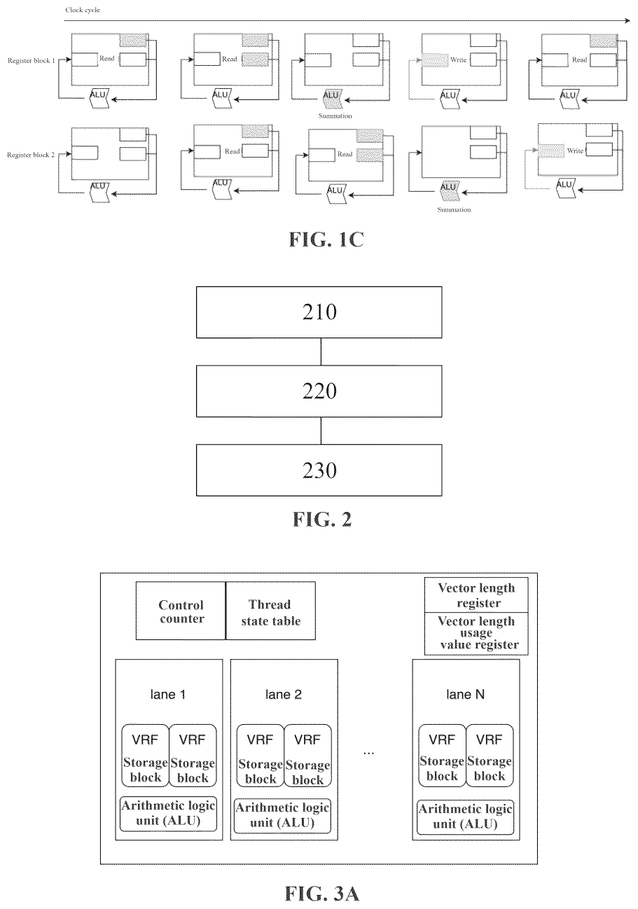

FIG. 1A to FIG. 1C show an example vector computation apparatus according to some embodiments of the present disclosure. The vector computation apparatus performs modular operations on elements in different vectors to combine modular operation results of the elements into modular operation results between different vectors. When the vector computation apparatus executes a vector modular operation, as shown in FIG. 1A to FIG. 1C, for example, a plurality of vectors V0 to V3 are stored in N computation channels. In general, the number of vectors is K=2^{k}, and k is a positive integer, for example, K=32 or 64. Each vector is stored in the corresponding vector register. Each box represents a position or an identifier of a vector element in a vector, and the vector length of each vector is 64. When N is 16, the block number of vector registers (i.e., the storage depth) is 64/16=4. That is, each vector register can store 4 elements of the same vector.

Further, a vector register file (VRF) is an example of a register unit 110 in the vector computation apparatus. Computation channels lane1, lane2, . . . , and laneN are examples of a plurality of computation channels. Each computation channel includes a first array and a second array formed by vector registers, i.e., VRF storage blocks. In the example of FIG. 1A, the first array and the second array store different elements of the same vector.

For example, the first array may be arranged with a corresponding execution unit, and the second array may also be arranged with a corresponding execution unit 120. The execution unit 120 reads elements of different vectors (e.g., through an output register 112), such as elements in vector V0 and elements in vector V1, executes a modular operation on the elements in vector V0 and the elements in vector V1, and writes a modular operation result in the register unit 110 (e.g., through an input register 111).

In some embodiments, the output register 112 includes an output register #1 and an output register #2. As shown in FIG. 1C, a register block 1 or a register block 2 needs to read the elements in vector V0 (e.g., through the output register #1) and then read the elements in vector V1 (e.g., through the output register #2), so that when the execution unit performs a vector operation, the cost of a clock cycle is relatively high, and the vector computation efficiency is relatively low.

FIG. 2 is a schematic block diagram of an example vector computation apparatus according to some embodiments of the present disclosure. The vector computation apparatus includes a register unit 210, a thread management unit 220, and a computation unit 230.

The register unit 210 includes circuitry configured to store a first vector and a second vector respectively. The register unit is divided into a plurality of computation channels, and each computation channel includes a first array having first registers and a second array having second registers. The first register is configured to store at least one first element of the first vector, and the second register is configured to store at least one second element of the second vector.

The thread management unit 220 includes circuitry configured to determine at least one thread according to the corresponding relationship between the at least one first element and the at least one second element.

The computation unit 230 includes circuitry including a plurality of execution units corresponding to the plurality of computation channels respectively. Each execution unit including circuitry configured to read the first element and the second element corresponding to each thread in the corresponding computation channel according to the at least one thread, to execute a modular operation between the first element and the second element corresponding to the thread, and to write a modular operation result in the first array or the second array in the computation channel.

In the embodiments of the present disclosure, each computation channel includes a first array having first registers and a second array having second registers. At least one thread is determined according to the corresponding relationship between at least one first element and at least one second element, and the first element and the second element can be efficiently read in one thread. Then, a modular operation between the first element and the second element is executed through each execution unit, thus improving the vector computation efficiency between the first vector and the second vector.

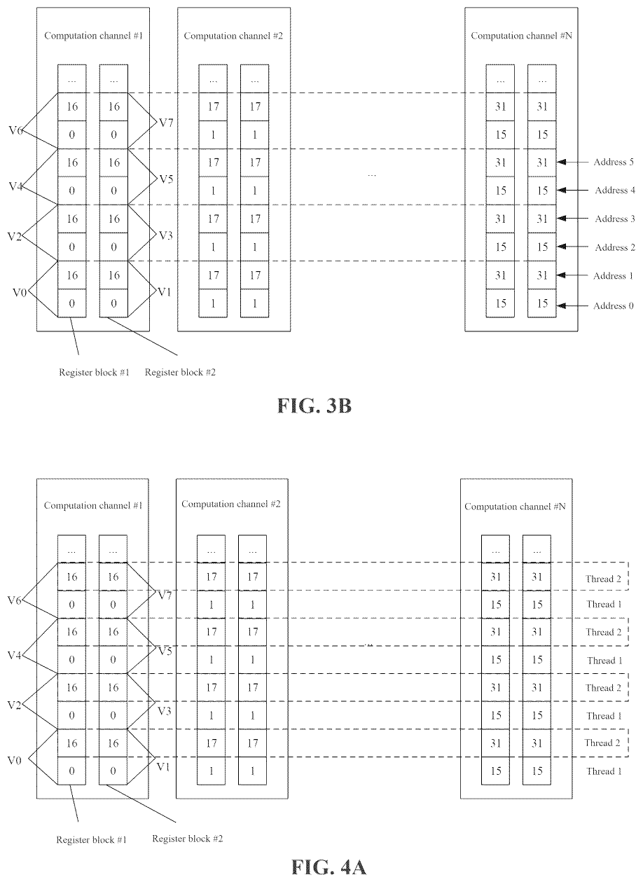

The embodiments of the vector computation apparatus in FIG. 2 will be described in detail below with reference to FIG. 3A and FIG. 3B. As shown in FIG. 3A, a vector register file (VRF) is an example of a register unit. Computation channels lane1, lane2, . . . , and laneN are examples of a plurality of computation channels. Each computation channel includes a first array having first registers and a second array having second registers, namely VRF storage blocks. The corresponding computation channel may also be arranged with an arithmetic logic unit (ALU) (an example of an execution unit), and the execution units form a computation unit. It should be understood that the execution unit may be arranged in the computation channel of the register unit or outside the register unit. For example, the execution unit may be arranged outside the register unit corresponding to the computation channel.

In the vector computation apparatus according to the embodiments of the present disclosure, a control counter, a thread state, a vector length register and a vector length usage value register may also be arranged.

Further, vector registers (such as first registers and second registers) are arranged in the register unit. A base address of the register unit can be computed based on the block number of registers (e.g., the block number indicates a storage depth, namely the number of vector elements allowed to be stored) as a unit. The block number of registers is related to the rated vector length that the register unit can store (e.g., a maximum vector length) and the number of computation channels. That is to say, the block number may be determined according to the proportional relationship between the rated vector length of the register unit and the number of the computation channels. For example, the block number may be equal to a multiple of the rated vector length of the register unit and the number of the computation channels.

That is, a base address of a vector register vi is (VLMAX/lane)*i, where VLMAX represents a maximum vector length allowed to be stored in the register unit, lane represents the number of channels, and i represents an identifier of a vector register.

Storage addresses of vector elements can be sorted as shown in FIG. 3B, which includes address 0, address 1, address 2, address 3, address 4, and address 5.

In addition, different from the example shown in FIG. 1A, in FIG. 3B, a plurality of vectors V0 to V7 are stored in N computation channels, and each box represents a position or an identifier of a vector element in a vector. The vector V0, vector V2, vector V4, vector V6 and the like are used as first registers to form the first array or used as second registers to form the second array. The vector V1, vector V3, vector V5, vector V7 and the like are used as second registers to form the second array or used as first registers to form the first array.

In addition, at least one thread in the embodiments of the present disclosure corresponds to the arrangement of the first array and the second array, that is, the block number of vector registers is the maximum number of threads of the at least one thread. For example, when VLMAX is 64 and lane is 16, the block number of vector registers is 64/16=4. Thus, in a case that each thread corresponds to one first element and one second element (i.e., the storage depth of the first vector and the second vector in the register unit is 1), that is, when VLUSE=16,the maximum number of threads is 64/16=4 when the execution unit in the first array or the second array executes a vector computation. Alternatively, each thread may correspond to a plurality of first elements and a plurality of second elements. For example, each thread corresponds to two first elements and two second elements (i.e., the storage depth of the first vector and the second vector in the register unit is 2). In this case, VLUSE=32, and the maximum number of threads is 64/32=2 when the execution unit in the first array or the second array executes a vector computation. In general, the maximum number of threads is VLMAX/VLUSE when the execution unit in the first array or the second array executes a vector computation.

When considering the factor of the number of threads, the base address of the vector register vi is (VLMAX/lane)*i+(VLUSE/lane)*k, where k represents a thread identifier, and VLUSE represents an actual vector length of the stored vector, such as an actual length of a vector in a current vector computation instruction, or a maximum vector length in each vector computation instruction in a vector computation task. In some embodiments, VLUSE represents the maximum vector length in each vector computation instruction in the vector computation task, and VLEN represents the actual vector length of the vector in the current vector computation instruction.

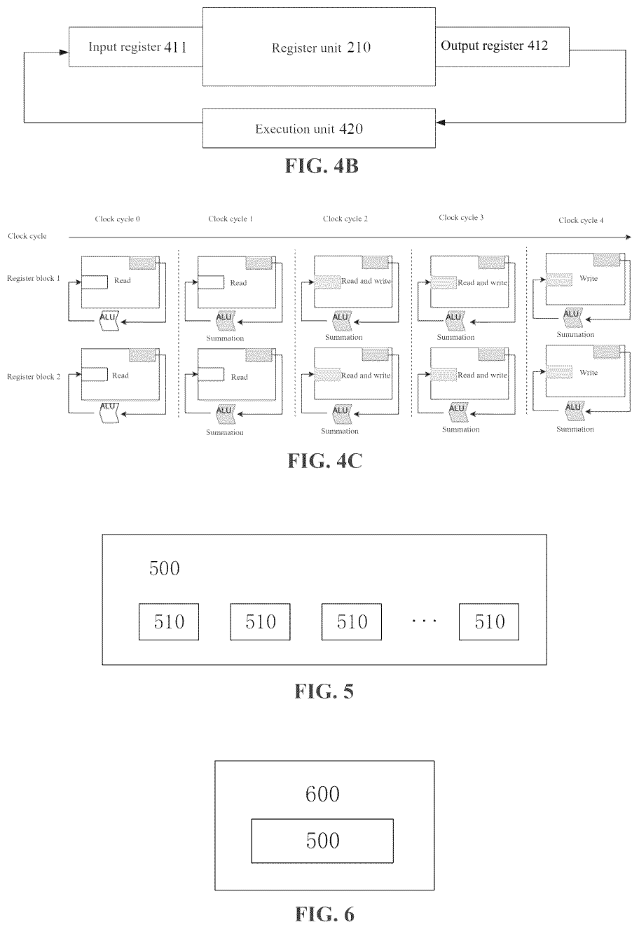

Further, other aspects of the embodiments of FIG. 2 are described with reference to FIG. 4A to FIG. 4C. As shown in FIG. 4A, each box represents a position or an identifier of a vector element in a vector. In a case that the actual length (VLEN or VLUSE) of the vectors V0 to V7 is 32, the vectors V0 to V7 fill the maximum vector length VLMAX of the register unit (i.e., the block number). At this time, because the elements corresponding to two threads (i.e., the thread 1 and the thread 2) belong to the same vector, the vectors V0 and V1 correspond to two threads (i.e., the thread 1 and the thread 2) that cannot be parallel. Similarly, the vectors V2 and V3 correspond to two threads (i.e., the thread 1 and the thread 2) that cannot be parallel, the vectors V4 and V5 correspond to two threads (i.e., the thread 1 and the thread 2) that cannot be parallel, and the vectors V6 and V7 correspond to two threads (i.e., the thread 1 and the thread 2) that cannot be parallel.

Alternatively, in a case that the actual length of the vectors V0 to V7 is 16 and the maximum vector length of the register unit is 32, the position of each register corresponding to the thread 2 does not store vector elements, and can be used for storing another vector. At this time, two threads, such as the thread 1 and the thread 2, can be executed in parallel.

In some embodiments, the execution unit is arranged corresponding to the first array or the second array, and parallel execution of two threads can be implemented by the execution unit of the first array and the execution unit of the second array in parallel. In general, each execution unit is arranged in the first array or the second array in the corresponding computation channel in the register unit.

In a case that the actual length (VLEN or VLUSE) of the vectors V0 to V7 is 32, for example, when a modular operation between the vector V0 (e.g., the first vector) and the vector V1 (e.g., the second vector) is executed, a modular operation result of the vector V0 and the vector V1 can be stored in the vector V2 or the vector V3.

For example, if the execution unit of the first array executes the above modular operation, the modular operation result is stored in the vector V2, and if the execution unit of the second array executes the above modular operation, the modular operation result is stored in the vector V3.

As an example of a parallel computation, the execution unit of the first array executes a modular operation between the vector V0 (e.g., the first vector) and the vector V1 (e.g., the second vector), and a modular operation result is stored in the vector V6. In parallel, the execution unit of the second array executes a modular operation between the vector V2 (e.g., the first vector) and the vector V3 (e.g., the second vector), and a modular operation result is stored in the vector V7. That is to say, in a case that the actual length (VLEN or VLUSE) of the first vector and the second vector is the same as the block number of vector registers, each thread of the execution unit of the first array is parallel to each thread of the execution unit of the second array, and the threads executed by the same execution unit are not parallel (e.g., in a case that the actual length of the vectors V0 to V7 is 16 and the maximum vector length of the register unit is 32). In general, in the register unit, the number of threads that can be parallel is VLMAX/VLEN or VLMAX/VLUSE.

FIG. 4B shows a schematic diagram of an example execution unit. An execution unit 420 reads a first element and a second element (e.g., through an output register 412), executes a modular operation between the first element and the second element, and writes a modular operation result in the register unit 210 (e.g., through an input register 411).

The thread management unit determines the current state of the thread management table based on the number of the current threads of the at least one thread, and the execution unit executes an operation based on the current state.

The state of the thread management table includes a composition of states of table entries indicating threads, where the states of the table entries indicating threads are as follows in Table 1.

TABLE 1

| State | Code |
|---|---|
| Invalid | (00)₂ |
| Working | (01)₂ |
| Pending | (10)₂ |

The above is only an example of using two bits to represent the state of a thread. It should be understood that more bits or other manners may also be used for representing the state of the thread, and the present embodiments are not limited thereto.

In a case that two bits are used for representing the state of the thread, different bit combinations can be used for achieving identifiers in different states.

The above invalid state represents the positions of the first element or the second element that do not store the current vector computation instruction in the vector register, or the positions of the first element or the second element in any vector computation state that do not store a vector computation task in the vector register, and such position does not correspond to a thread.

The working state and the pending state belong to valid states. The valid state represents the positions of the first element or the second element that store the current vector computation instruction in the vector register, or the positions of the first element or the second element in any vector computation state that store a vector computation task in the vector register.

It should be understood that in a case that the valid state represents the positions of the first element and the second element in any vector computation state that store a vector computation task in the vector register, the consistency of thread management for all vector computations in the vector computation task can be ensured. In a case that the vector register does not store the position of the first element or the second element in a vector computation instruction, the thread corresponding to this position can be set to pending.

In a case that the valid state represents the positions of the first element or the second element that store the current vector computation instruction in the vector register, the computational efficiency of each vector computation instruction in the vector computation task can be ensured.

In general, the pending state refers to a pending thread among threads that cannot be parallel, and the working state refers to a working thread.

In general, the vector computation apparatus further includes a scheduling unit. The scheduling unit includes circuitry configured to analyze the current vector computation instruction to obtain actual vector lengths of the first vector and the second vector.

An example of the thread management table is as follows in Table 2.

TABLE 2

| Thread 1 | Thread 2 | Thread 3 | Thread 4 | . . . | . . . | Thread M |
|---|---|---|---|---|---|---|
| (10)₂ | (01)₂ | (00)₂ | (00)₂ | (00)₂ | (00)₂ | (00)₂ |

In the above example, M=VLMAX/lane. There are two valid threads (i.e., the thread 1 and the thread 2), and other threads are all invalid threads. As mentioned above, in general, in the register unit, the number of threads that can be parallel is VLMAX/VLEN or VLMAX/VLUSE. Without considering VLEN, the number of threads that can be parallel is VLMAX/VLUSE.

In general, the thread management unit includes circuitry further configured to determine the number of the current threads of the at least one thread based on the proportional relationship between the actual vector length and the number of the computation channels, and to determine the current state of the thread management table based on the number of the current threads of the at least one thread.

In general, the at least one thread includes a first thread and a second thread which are executed continuously. Correspondingly, each execution unit is specifically configured to execute a modular operation between the first element and the second element corresponding to the first thread and read the first element and the second element corresponding to the second thread in the corresponding computation channel during a first clock cycle.

In general, the scheduling unit includes circuitry further configured to analyze each vector computation instruction in a vector computation task to obtain vector length thresholds of the first vector and the second vector. Correspondingly, the thread management unit includes circuitry further configured to determine a threshold of the number of threads of the at least one thread based on the proportional relationship between the vector length threshold and the number of the computation channels, and to configure the thread management table based on the threshold of the number of threads.

In the example of FIG. 4B, taking a modular operation between the vector V0 and the vector V1 as an example, the addresses of the element V0₀ of the vector V0 and the element V1₀ of the vector V1 are the base address of the vector V0 as well as the base address of the vector V1.

The addresses of the element V0₁₆ of the vector V0 and the element V1₁₆ of the V1 are the base address of the vector V0+1 (e.g., an offset address). When VLMAX/lane>2, for example, when VLMAX/lane=4 or 8, the offset address of the next first element in the first register may be the offset address of the previous first element+1, and the offset address of the next second element in the second register may be the offset address of the previous second element+1.

In general, each execution unit is specifically configured to determine a base address of the first register or the second register in the register unit, read the first element and the second element corresponding to the first thread from an offset address corresponding to the first thread based on the base address, and read the first element and the second element corresponding to the second thread based on the next adjacent address of the offset address corresponding to the first thread.

Further, as shown in FIG. 4C, a register block 1 is an example of the first array, and a register block 2 is an example of the second array.

During a clock cycle 0, the execution unit corresponding to the register block 1 and the execution unit corresponding to the register block 2 execute parallel read operations.

During clock cycles 1 to 4, the execution unit corresponding to the register block 1 and the execution unit corresponding to the register block 2 execute parallel modular operations such as summation.

In addition, each execution unit is specifically configured to execute a modular operation between the first element and the second element corresponding to the first thread and read the first element and the second element corresponding to the second thread in the corresponding computation channel during a first clock cycle. Further, each execution unit is further configured to write a modular operation result of the first element and the second element corresponding to the first thread in a first register block of the first array or the second array and execute a modular operation between the first element and the second element corresponding to the second thread in the corresponding computation channel during a second clock cycle.

Here, the second clock cycle is the next clock cycle of the first clock cycle, and the first clock cycle may be any clock cycle.

A processor 500 according to some embodiments of the present disclosure is described below with reference to FIG. 5. The processor 500 includes a plurality of processor cores 510, and each processor core 510 is configured as the vector computation apparatus 200.

A system on chip 600 according to some embodiments of the present disclosure is described below with reference to FIG. 6. The system on chip 600 includes the processor 500.

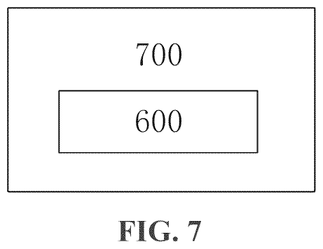

An electronic device 700 according to some embodiments of the present disclosure is described below with reference to FIG. 7. The electronic device 700 includes the system on chip 600.

The specific implementation of each step in a program may refer to the corresponding description in the corresponding step and unit in the above apparatus embodiments, and has corresponding beneficial effects, which are not repeated here. Those skilled in the art can clearly understand that for the convenience and simplicity of description, for the specific working processes of the devices and modules described above, reference may be made to the corresponding description of processes in the above apparatus embodiments, and the description will not be repeated here.

In addition, it should be noted that the user-related information (including but not limited to user equipment information, user personal information, etc.) and data (including but not limited to sample data for training models, data for analysis, stored data, displayed data, etc.) involved in the embodiments of the present disclosure are all information and data authorized by users or fully authorized by all parties. Furthermore, the collection, use and processing of relevant data need to comply with relevant regulations and standards, and corresponding operation entrances are provided for users to choose to authorize or reject.

It is to be noted that according to the needs of implementation, each component/step described in the embodiments of the present disclosure can be split into more components/steps, or two or more components/steps or partial operations of components/steps can be combined into new components/steps to achieve the purposes of the embodiments of the present disclosure.

The above apparatus according to the embodiments of the present disclosure may be implemented in hardware and firmware, or implemented as software or computer codes which can be stored in a recording medium (such as a CD-ROM, a RAM, a floppy disk, a hard disk or a magneto-optical disk), or implemented as computer codes which are downloaded through a network, originally stored in a remote recording medium or a non-temporary machine-readable medium and to be stored in a local recording medium, so that the apparatus described herein can be processed by such software stored on the recording medium using a general-purpose computer, a dedicated processor or programmable or dedicated hardware (such as an application specific integrated circuit (ASIC) or a field programmable gate array (FPGA)). It can be understood that a computer, a processor, a microprocessor controller or programmable hardware includes a storage component (such as a random access memory (RAM), a read-only memory (ROM), or a flash memory) which can store or receive software or computer codes. When the software or computer codes are accessed and executed by the computer, the processor or the hardware, the operation described herein is implemented. In addition, when the general-purpose computer accesses the codes for implementing the operation shown herein, the execution of the codes converts the general-purpose computer into a dedicated computer for executing the operation shown herein.

Those of ordinary skill in the art may notice that the exemplary units and operation steps described with reference to the embodiments disclosed in this specification can be implemented in electronic hardware, or a combination of computer software and electronic hardware. Whether the functions are executed in a mode of hardware or software depends on particular applications and design constraint conditions of the technical solutions. Those skilled in the art may use different operations to implement the described functions for each particular application, but it should not be considered that the implementation goes beyond the scope of the embodiments of the present disclosure.

The embodiments may further be described using the following clauses:
1: A vector computation apparatus, comprising: a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector; a thread management unit including circuitry configured to determine at least one thread according to a corresponding relationship between the at least one first element and the at least one second element; and a computation unit including circuitry comprising a plurality of execution units corresponding to the plurality of computation channels respectively, each execution unit of the plurality of execution units including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.
2: The vector computation apparatus as paragraph 1 describes, wherein the thread management unit is configured with a rated number of threads, and the rated number of threads is consistent with a block number of the first register and the second register.
3: The vector computation apparatus as paragraph 2 describes, wherein the block number is determined according to a proportional relationship between a rated vector length of the register unit and the number of the plurality of computation channels.
4: The vector computation apparatus as any of paragraphs 1-3 describes, further comprising: a scheduling unit including circuitry configured to analyze a current vector computation instruction to obtain an actual vector length of the first vector and the second vector; wherein, correspondingly, the thread management unit includes circuitry further configured to: determine the number of current threads of the at least one thread based on a proportional relationship between the actual vector length and the number of the plurality of computation channels; and determine a current state of a thread management table based on the number of the current threads of the at least one thread.
5: The vector computation apparatus as paragraph 4 describes, wherein the scheduling unit includes circuitry further configured to analyze each vector computation instruction in a vector computation task to obtain a vector length threshold of the first vector and the second vector, and correspondingly, the thread management unit further includes circuitry configured to: determine a threshold of the number of threads of the at least one thread based on a proportional relationship between the vector length threshold and the number of the plurality of computation channels; and configure the thread management table based on the threshold of the number of threads.
6: The vector computation apparatus as any of paragraphs 1-5 describes, wherein the at least one thread comprises a first thread and a second thread executed continuously, and correspondingly, each execution unit is configured to, during a first clock cycle, execute the modular operation between the first element and the second element corresponding to the first thread and read the first element and the second element corresponding to the second thread in the corresponding computation channel.
7: The vector computation apparatus as paragraph 6 describes, wherein each execution unit is configured to: determine a base address of the first register or the second register in the register unit, and read the first element and the second element corresponding to the first thread from an offset address corresponding to the first thread based on the base address; and read the first element and the second element corresponding to the second thread based on the next adjacent address of the offset address corresponding to the first thread.
8: The vector computation apparatus as paragraph 6 or paragraph 7 describes, wherein each execution unit is configured to, during a second clock cycle, in the corresponding computation channel, write the modular operation result of the first element and the second element corresponding to the first thread in a first register block of the first array or the second array, and execute the modular operation between the first element and the second element corresponding to the second thread.
9: The vector computation apparatus as any of paragraphs 1-8 describes, wherein each execution unit is arranged in the first array or the second array in the corresponding computation channel in the register unit.
10: A processor comprising: a plurality of processor cores, each processor core being configured as a vector computation apparatus comprising: a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector; a thread management unit including circuitry configured to determine at least one thread according to a corresponding relationship between the at least one first element and the at least one second element; and a computation unit including circuitry comprising a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.
11: The processor as paragraph 10 describes, wherein the thread management unit is configured with a rated number of threads, and the rated number of threads is consistent with a block number of the first register and the second register.
12: The processor as either of paragraph 11 describes, wherein the block number is determined according to a proportional relationship between a rated vector length of the register unit and the number of the plurality of computation channels.
13: The processor as any of paragraphs 10-12 describes, wherein the vector computation apparatus further comprises: a scheduling unit including circuitry configured to analyze a current vector computation instruction to obtain an actual vector length of the first vector and the second vector; wherein, correspondingly, the thread management unit includes circuitry further configured to: determine the number of current threads of the at least one thread based on a proportional relationship between the actual vector length and the number of the plurality of computation channels; and determine a current state of a thread management table based on the number of the current threads of the at least one thread.
14: The processor as any of paragraph 13 describes, wherein the scheduling unit includes circuitry further configured to analyze each vector computation instruction in a vector computation task to obtain a vector length threshold of the first vector and the second vector, and correspondingly, the thread management unit further includes circuitry configured to: determine a threshold of the number of threads of the at least one thread based on a proportional relationship between the vector length threshold and the number of the plurality of computation channels; and configure the thread management table based on the threshold of the number of threads.
15: The processor as any of paragraphs 10-14 describes, wherein the at least one thread comprises a first thread and a second thread executed continuously, and correspondingly, each execution unit is configured to, during a first clock cycle, execute the modular operation between the first element and the second element corresponding to the first thread and read the first element and the second element corresponding to the second thread in the corresponding computation channel.
16: The processor as any of paragraph 15 describes, wherein each execution unit is configured to: determine a base address of the first register or the second register in the register unit, and read the first element and the second element corresponding to the first thread from an offset address corresponding to the first thread based on the base address; and read the first element and the second element corresponding to the second thread based on the next adjacent address of the offset address corresponding to the first thread.
17: The processor as paragraph 15 or paragraph 16 describes, wherein each execution unit is configured to, during a second clock cycle, in the corresponding computation channel, write the modular operation result of the first element and the second element corresponding to the first thread in a first register block of the first array or the second array, and execute the modular operation between the first element and the second element corresponding to the second thread.
18: The processor as any of paragraphs 10-17 describe, wherein each execution unit is arranged in the first array or the second array in the corresponding computation channel in the register unit.
19: A system on chip, comprising: a processor comprising a plurality of processor cores, each processor core being configured as a vector computation apparatus comprising: a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector; a thread management unit including circuitry configured to determine at least one thread according to a corresponding relationship between the at least one first element and the at least one second element; and a computation unit including circuitry comprising a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.
20: The system on chip as paragraph 19 describes, wherein the system on chip is included in an electronic device.
21: An electronic device, comprising: a system on chip comprising a processor, wherein the processor comprises a plurality of processor cores and each processor core is configured as a vector computation apparatus comprising: a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector; a thread management unit including circuitry configured to determine at least one thread according to a corresponding relationship between the at least one first element and the at least one second element; and a computation unit including circuitry comprising a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

The above implementations are only used to illustrate the embodiments of the present disclosure, but are not intended to limit the embodiments of the present disclosure. Those of ordinary skill in the art can also make various changes and modifications without departing from the spirit and scope of the embodiments of the present disclosure. Therefore, all equivalent technical solutions also fall within the scope of the embodiments of the present disclosure, and the patent protection scope of the embodiments of the present disclosure should be limited by the claims.

What is claimed is:

1. A vector computation apparatus, comprising:
a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector;
a thread management unit including circuitry configured to determine at least one thread according to a corresponding relationship between the at least one first element and the at least one second element; and
a computation unit including circuitry comprising a plurality of execution units corresponding to the plurality of computation channels respectively, each execution unit of the plurality of execution units including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

2. The vector computation apparatus of claim 1, wherein the thread management unit is configured with a rated number of threads, and the rated number of threads is consistent with a block number of the first register and the second register.

3. The vector computation apparatus of claim 2, wherein the block number is determined according to a proportional relationship between a rated vector length of the register unit and the number of the plurality of computation channels.

4. The vector computation apparatus of claim 1, further comprising:
a scheduling unit including circuitry configured to analyze a current vector computation instruction to obtain an actual vector length of the first vector and the second vector;
wherein, correspondingly, the thread management unit includes circuitry further configured to:
determine the number of current threads of the at least one thread based on a proportional relationship between the actual vector length and the number of the plurality of computation channels; and
determine a current state of a thread management table based on the number of the current threads of the at least one thread.

5. The vector computation apparatus of claim 4, wherein the scheduling unit includes circuitry further configured to analyze each vector computation instruction in a vector computation task to obtain a vector length threshold of the first vector and the second vector, and correspondingly, the thread management unit further includes circuitry configured to:
determine a threshold of the number of threads of the at least one thread based on a proportional relationship between the vector length threshold and the number of the plurality of computation channels; and
configure the thread management table based on the threshold of the number of threads.

6. The vector computation apparatus of claim 1, wherein the at least one thread comprises a first thread and a second thread executed continuously, and correspondingly, each execution unit is configured to, during a first clock cycle, execute the modular operation between the first element and the second element corresponding to the first thread and read the first element and the second element corresponding to the second thread in the corresponding computation channel.

7. The vector computation apparatus of claim 6, wherein each execution unit is configured to: determine a base address of the first register or the second register in the register unit, and read the first element and the second element corresponding to the first thread from an offset address corresponding to the first thread based on the base address; and
read the first element and the second element corresponding to the second thread based on the next adjacent address of the offset address corresponding to the first thread.

8. The vector computation apparatus of claim 6, wherein each execution unit is configured to, during a second clock cycle, in the corresponding computation channel, write the modular operation result of the first element and the second element corresponding to the first thread in a first register block of the first array or the second array, and execute the modular operation between the first element and the second element corresponding to the second thread.

9. The vector computation apparatus of claim 1, wherein each execution unit is arranged in the first array or the second array in the corresponding computation channel in the register unit.

10. A processor comprising:
a plurality of processor cores, each processor core being configured as a vector computation apparatus comprising:
a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector;
a thread management unit including circuitry configured to determine at least one thread according to a corresponding relationship between the at least one first element and the at least one second element; and
a computation unit including circuitry comprising a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

11. The processor of claim 10, wherein the thread management unit is configured with a rated number of threads, and the rated number of threads is consistent with a block number of the first register and the second register.

12. The processor of claim 11, wherein the block number is determined according to a proportional relationship between a rated vector length of the register unit and the number of the plurality of computation channels.

13. The processor of claim 10, wherein the vector computation apparatus further comprises:
a scheduling unit including circuitry configured to analyze a current vector computation instruction to obtain an actual vector length of the first vector and the second vector;
wherein, correspondingly, the thread management unit includes circuitry further configured to:
determine the number of current threads of the at least one thread based on a proportional relationship between the actual vector length and the number of the plurality of computation channels; and
determine a current state of a thread management table based on the number of the current threads of the at least one thread.

14. The processor of claim 13, wherein the scheduling unit includes circuitry further configured to analyze each vector computation instruction in a vector computation task to obtain a vector length threshold of the first vector and the second vector, and correspondingly, the thread management unit further includes circuitry configured to:
determine a threshold of the number of threads of the at least one thread based on a proportional relationship between the vector length threshold and the number of the plurality of computation channels; and
configure the thread management table based on the threshold of the number of threads.

15. The processor of claim 10, wherein the at least one thread comprises a first thread and a second thread executed continuously, and correspondingly, each execution unit is configured to, during a first clock cycle, execute the modular operation between the first element and the second element corresponding to the first thread and read the first element and the second element corresponding to the second thread in the corresponding computation channel.

16. The processor of claim 15, wherein each execution unit is configured to: determine a base address of the first register or the second register in the register unit, and read the first element and the second element corresponding to the first thread from an offset address corresponding to the first thread based on the base address; and
read the first element and the second element corresponding to the second thread based on the next adjacent address of the offset address corresponding to the first thread.

17. The processor of claim 15, wherein each execution unit is configured to, during a second clock cycle, in the corresponding computation channel, write the modular operation result of the first element and the second element corresponding to the first thread in a first register block of the first array or the second array, and execute the modular operation between the first element and the second element corresponding to the second thread.

18. The processor of claim 10, wherein each execution unit is arranged in the first array or the second array in the corresponding computation channel in the register unit.

19. A system on chip, comprising:
a processor comprising a plurality of processor cores, each processor core being configured as a vector computation apparatus comprising:
a register unit including circuitry configured to store a first vector and a second vector respectively, the register unit being divided into a plurality of computation channels, each computation channel comprising a first array comprising a first register configured to store at least one first element of the first vector and a second array comprising a second register configured to store at least one second element of the second vector;
a thread management unit including circuitry configured to determine at least one thread according to a corresponding relationship between the at least one first element and the at least one second element; and
a computation unit including circuitry comprising a plurality of execution units corresponding to the plurality of computation channels respectively, each execution unit including circuitry configured to read the first element and the second element corresponding to each thread in the corresponding computation channel according to the at least one thread, to execute a modular operation between the first element and the second element corresponding to the thread, and to write a modular operation result in the first array or second array in the computation channel.

20. The system on chip of claim 19, wherein the system on chip is included in an electronic device.
